(19) United States
(12) Patent Application Publication
(10) Pub. No.: US 2014/0322439 A1
(43) Pub. Date: Oct. 30, 2014

(54) APPARATUS AND METHOD FOR MANUFACTURING OPTICAL COMPOUND FILM

(71) Applicant: HON HAI PRECISION INDUSTRY CO., LTD., New Tapei (TW)

(72) Inventor: YUNG-CHANG TSENG, New Taipei (TW)

(73) Assignee: HON HAI PRECISION INDUSTRY CO., LTD., New Taipei (TW)

(21) Appl. No.: 13/951,584

(22) Filed: Jul. 26, 2013

(30) Foreign Application Priority Data
Apr. 25, 2013 (TW) 102114861

(51) Int. Cl. G02B 5/02

(52) U.S. Cl. CPC G02B 5/0268
USPC 427/164; 118/56; 118/620; 427/162

(57) ABSTRACT

A method of manufacturing an optical compound film includes providing a substrate, a first surface of the substrate facing upwards. A first curable glue is applied on the first surface. The first curable glue is pressed by a first roller with a rough circumferential surface to form a rough surface on the first curable glue. The first curable glue is cured to form a diffusion layer. The substrate is turned over to make a second surface of the substrate face upwards. A second curable glue is applied on the second surface. The second curable glue is pressed by a second roller having a micro-prism-structured circumferential surface to form a micro-prism-structured surface on the second curable glue. The second curable glue is cured to form a brightness-enhancing layer.

### BACKGROUND

1. Technical Field

The present disclosure relates to an apparatus and a method for manufacturing an optical compound film.

2. Description of Related Art

An optical compound film includes a substrate, a diffusion layer formed on a first surface of the substrate, and a brightness-enhancing layer formed on a second surface of the substrate. Diffusion particles are disposed on the diffusion layer, but it is difficult to make the diffusion particles evenly distribute on the diffusion layer. This affects the diffusion effect of the optical compound film.

Therefore, it is desirable to provide an apparatus and a method of manufacturing the optical compound film which can overcome the limitations described.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of an apparatus for manufacturing an optical compound film according to a first embodiment of the present disclosure.

FIG. 2 is an enlarged view of a circled part II of FIG. 1.

FIG. 3 is an enlarged view of a circled part III of FIG. 1.

FIG. 4 is a flow chart of a method of manufacturing the optical compound film according to a second embodiment of the present disclosure.

### DETAILED DESCRIPTION

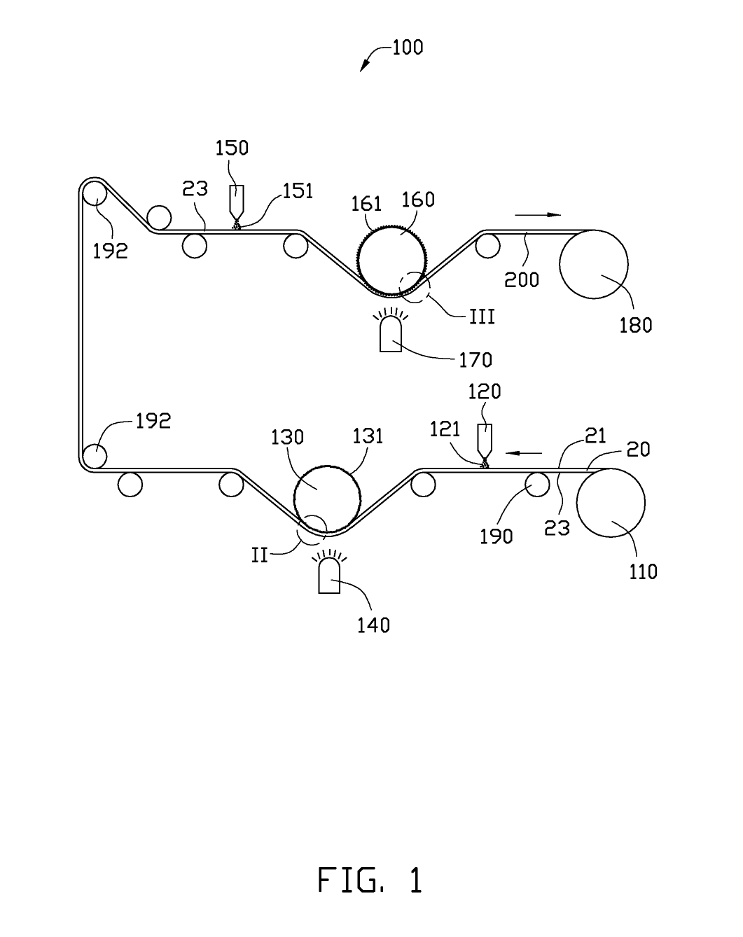

FIG. 1 shows an apparatus 100 of manufacturing an optical compound film according to a first embodiment. The apparatus 100 includes an unwinding device 110, a first coating device 120, a first roller 130, a first solidifying device 140, a second coating device 150, a second roller 160, a second solidifying device 170, a rewinding device 180, a transmitting device 190, and a plurality of turning rollers 192.

The unwinding device 110 is configured to release a transparent flexible substrate 20. In this embodiment, the substrate 20 is made of polyethylene terephthalate (PET). The substrate 20 includes a first surface 21 and an opposite second surface 23. The unwinding device 110 releases the substrate 20 to make the first surface 21 face upwards.

The transmitting device 190 is a number of assisting rollers. In this embodiment, the number of the assisting rollers 190 is eight. The assisting rollers 190 support the substrate 20 and rotate to make the substrate 20 move along a predetermined route.

The first coating device 120, the first roller 130, the turning rollers 192, the second coating device 150, the second roller 160, and the rewinding device 180 are arranged in sequence along a moving direction of the substrate 20.

The first coating device 120 is positioned above the substrate 20. The first coating device 120 is used to apply a layer of first curable glue 121 on the first surface 21 of the substrate 20. In this embodiment, the first curable glue 121 is ultraviolet (UV) curable glue.

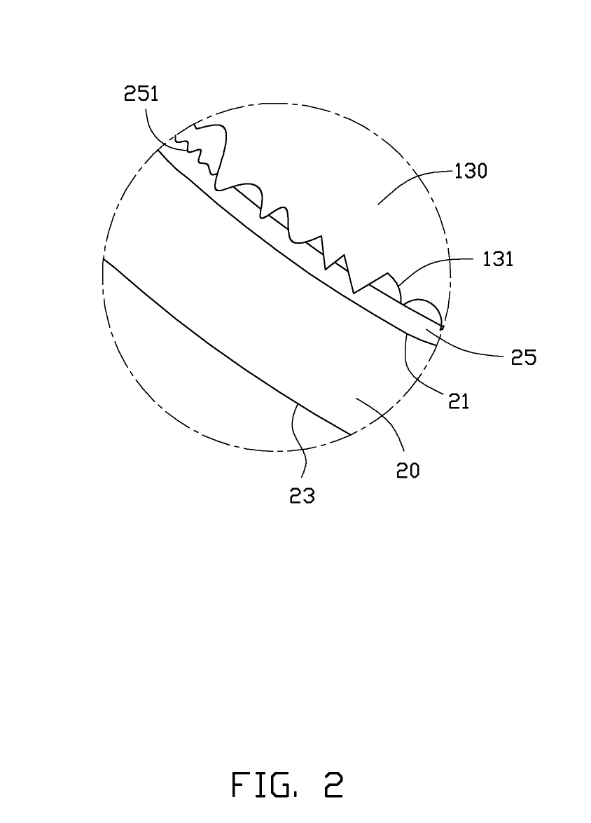

Referring also to FIG. 2, the first roller 130 includes a circumferential surface 131. The first roller 130 can be made of copper or transparent resin. The circumferential surface 131 is a rough surface formed by sand-blasting. The first roller 130 rotates around a central axis of the first roller 130 and presses the substrate 20, thus forming a rough surface 251 on the first curable glue 121.

The first solidifying device 140 solidifies the first curable glue 121 to obtain a diffusion layer 25. In this embodiment, the first solidifying device 140 is a UV-ray source. The first solidifying device 140 emits UV-rays towards the substrate 20. The first solidifying device 140 is aligned with the first roller 130 and is positioned below the substrate 20.

The substrate 20 with the diffusion layer 25 is turned over around the turning rollers 192, such that the second surface 23 of the substrate 20 faces upwards. In this embodiment, there are two of the turning rollers 192 spaced at a predetermined distance.

The second coating device 150 is positioned above the substrate 20. The second coating device 150 is used to apply a layer of second curable glue 151 on the second surface 23 of the substrate 20. In this embodiment, the second curable glue is UV curable glue.

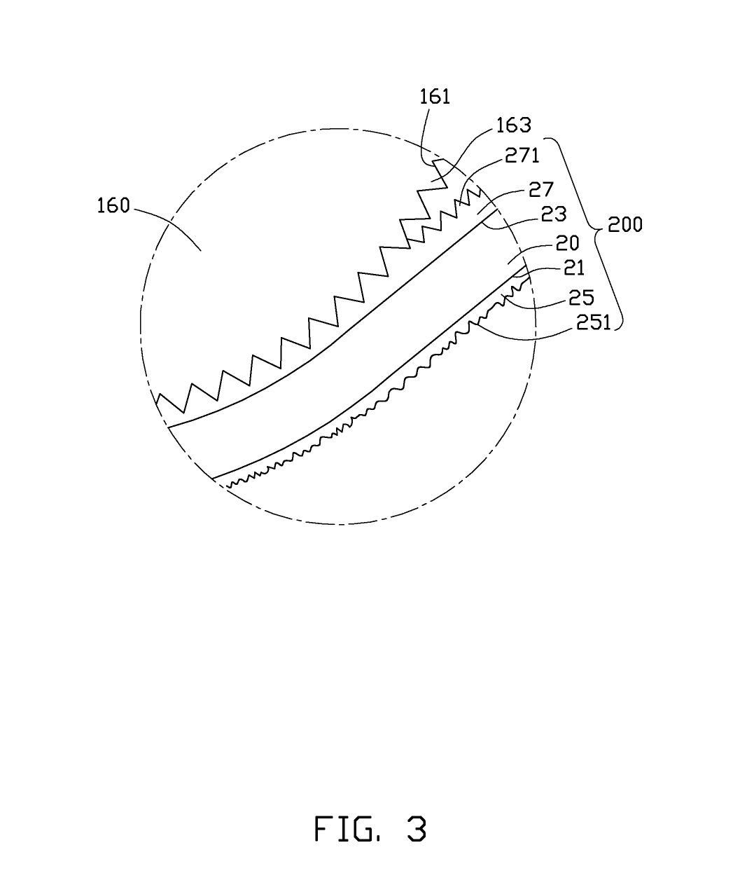

Referring also to FIG. 3, the second roller 160 includes a circumferential surface 161. The second roller 160 can be made of copper or transparent resin. Micro-prism structures 163 are formed on the circumferential surface 161 by ultra-precision machining, such as diamond knife machining or laser machining. The second roller 160 rotates around a central axis of the second roller 160 and presses the substrate 20, thus forming a micro-prism structured surface 271 on the second curable glue 151.

The second solidifying device 170 solidifies the second curable glue 151 to obtain a brightness-enhancing layer 27. In this embodiment, the second solidifying device 170 is a UV-ray source. The second solidifying device 170 is aligned with the second roller 160 and is positioned below the substrate 20. The second solidifying device 170 emits UV-rays towards the substrate 20. The substrate 20, the diffusion layer 25, and the brightness-enhancing layer 27 constitute an optical compound film 200.

The rewinding device 180 winds the optical compound film 200.

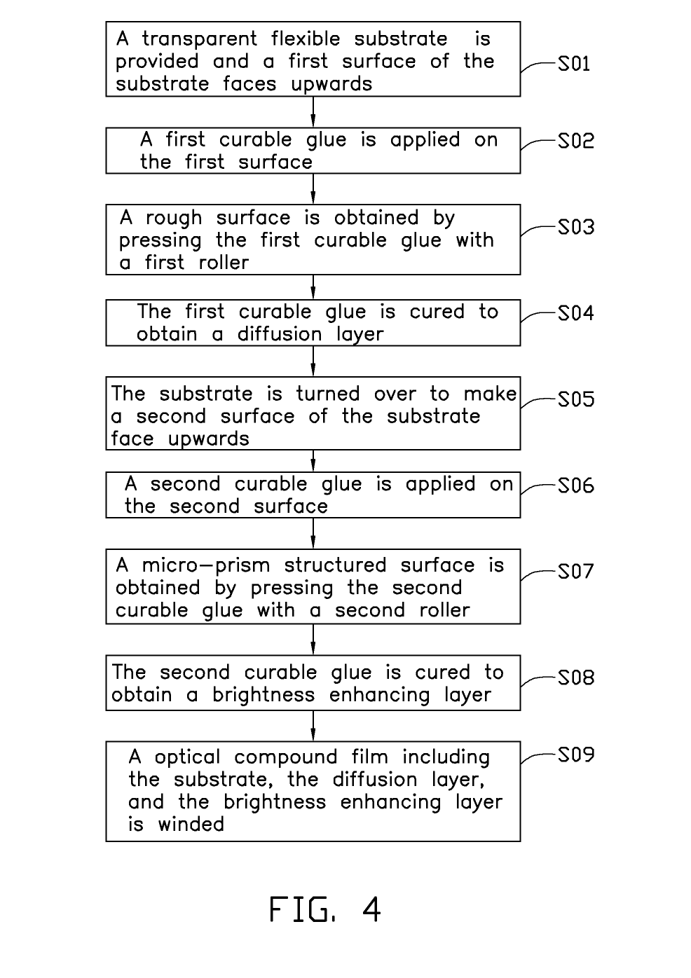

FIG. 4 shows a method of manufacturing the optical compound film 200 according to a second embodiment. The method includes steps described below.

In step S01, the transparent substrate 20 is provided. The transparent substrate 20 includes the first surface 21 and the second surface 23 opposite to the first surface 21. The first surface 21 faces upwards. In this embodiment, the transparent substrate 20 is unwound by the unwinding device 110.

In step S02, the first curable glue 121 is applied on the first surface 21.

In step S03, the rough surface 251 is formed on the first curable glue 121 by using the first roller 130 to press the first curable glue 121.

In step S04, the first curable glue 121 is cured to obtain the diffusion layer 25.

In step S05, the substrate 20 is turned over to make the second surface 23 face upwards.

In step S06, the second curable glue 151 is applied on the second surface 23.

In step S07, the micro-prism structured surface 271 is obtained by using the second roller 160 to press the second curable glue 151.

In step S08, the second curable glue 151 is cured to obtain the brightness-enhancing layer 27. The substrate 20, the diffusion layer 25, and the brightness-enhancing layer 27 constitute the optical compound film 200.

In step S09, the optical compound film 200 is rewound by the rewinding device 180.

The diffusion layer 25 has no diffusion particles. The diffusion effect of the diffusion layer 25 is achieved by the rough surface 251. Thus, the diffusion effect of the optical compound film 200 is enhanced.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. An apparatus of manufacturing an optical compound film, the optical compound film comprising a substrate comprising a first surface and a second surface opposite to the first surface, a diffusion layer formed on the first surface, and a brightness-enhancing layer formed on the second surface, the apparatus comprising:
a transmitting device configured to support and transmit the substrate, the first surface facing upwards;
a first coating device configured to apply a layer of first curable glue on the first surface;
a first roller comprising a rough circumferential surface and configured to press the first curable glue to make the first curable glue having a rough surface;
a first solidifying device configured to cure the first curable glue to obtain the diffusion layer;
turning rollers configured to turn over the substrate to make the second surface face upwards;
a second coating device configured to apply a layer of second curable glue on the second surface;
a second roller comprising a micro-prism structured circumferential surface and configured to press the second curable glue to make the second curable glue have a micro-prism structured surface; and
a second solidifying device configured to cure the second curable glue to obtain the brightness-enhancing layer.

2. The apparatus of claim 1, wherein the substrate is a transparent flexible substrate.

3. The apparatus of claim 2, further comprising an unwinding device configured to release the transparent flexible substrate.

4. The apparatus of claim 2, further comprising a rewinding device configured to wind the optical compound film.

5. The apparatus of claim 1, wherein the first roller and the second roller are copper rollers.

6. The apparatus of claim 1, wherein the first solidifying device and the second solidifying device are ultraviolet-ray sources.

7. A method of manufacturing an optical compound film, the optical compound film comprising a substrate comprising a first surface and a second surface opposite to the first surface, a diffusion layer formed on the first surface, and a brightness-enhancing layer formed on the second surface, the method comprising:
providing the substrate, with the first surface facing upwards;
applying a first curable glue on the first surface;
pressing the first curable glue to obtain a rough surface by a fist roller having a rough circumferential surface;
curing the first curable glue to obtain the diffusion layer;
turning over the substrate to make the second surface face upwards;
applying a second curable glue on the second surface;
pressing the second curable glue to obtain a micro-prism structured surface by a second roller having a micro-prism structured circumferential surface; and
curing the second curable glue to obtain the brightness-enhancing layer.

8. The method of claim 7, wherein the substrate is a transparent flexible substrate.

9. The method of claim 8, wherein the step of providing the substrate comprises a step of unwinding the substrate by an unwinding device.

10. The method of claim 8, further comprising winding the optical compound film by a rewinding device.
